(19) United States
(12) Patent Application Publication
(10) Pub. No.: US 2019/0353925 A1
(43) Pub. Date: Nov. 21, 2019

(54) PRINTED MULTIFOCAL LENS AND METHOD FOR PRINTING A MULTIFOCAL LENS

(71) Applicant: LUXEXCEL HOLDING B.V., Eindhoven (NL)

(72) Inventors: Joris Biskop, Vlissingen (NL); Guido Groet, Oud-Turnhout (BE)

(21) Appl. No.: 16/468,403

(22) PCT Filed: Nov. 27, 2017
(86) PCT No.: PCT/EP2017/080546

§ 371 Date: Jun. 11, 2019

(30) Foreign Application Priority Data
Dec. 12, 2016 (EP) 16203421.9

(51) Int. Cl. G02C 7/02; G02C 7/06; B29C 64/112; B29D 11/00; B33Y 10/00; B33Y 80/00

(52) U.S. Cl. CPC G02C 7/022; G02C 7/06; B33Y 80/00; B29D 11/00028; B33Y 10/00; B29C 64/112

(57) ABSTRACT

The present invention refers to a multifocal lens, in particular ophthalmic multifocal lens, being built in an inkjet printing process of depositing droplets of printing ink side by side and one above the other in several consecutive depositing steps and curing them in intermediate curing steps, wherein the multifocal lens comprises a first section providing a first optical function and a second section providing a second optical function that differs from the first optical function. The present invention further relates to a corresponding method.

### BACKGROUND

The present invention relates to a multifocal lens, in particular an ophthalmic multifocal lens, being built in an inkjet printing process.

Multifocal lenses, i.e. optical lenses with at least two different focal lengths are known from the prior art. In particular, multifocal lenses are used to correct presbyobia. Until recently, bifocal or trifocal lenses were used in the treatment of presbyobia. A bifocal lens comprises an upper part of the lens providing an optical power suitable for distance vision. The lower part of the bifocal lens comprises a conventionally D-shaped segment, the so-called add segment, providing an optical power suitable for near vision.

A segment line separates the two sections. Typically, for a wearer with myopia the upper part of the bifocal lens provides a certain diverging power while the add segment of the lens provides a lower diverging power for close-up work. Similarly, for a wearer with hyperopia the upper part of the lens provides a certain converging power and the add segment provides a greater power for close-up work.

A trifocal lens additionally provides a second add segment with an optical power suitable for intermediate distance vision, e.g. computer distance. Across each segment line the optical power changes discontinuously, causing image-jumps in the visual field of the wearer. Furthermore, the discontinuity in the optical power across each segment line leads to cosmetically unattractive jumps in the face of the wearer as seen by others.

More recently, progressive multifocal lenses have gained popularity over the multifocal lenses. Progressive multifocal lenses, or simply progressive lenses, provide a smooth transition from distance correction to near correction. A progressive lens is a segment-line free multifocal lens, also called no-line multifocal lens.

It is a drawback of progressive lenses that they provide peripherally distorted images to the wearer as a result of the power progression, wherein ‘peripherally’ describes the region of the lens away from the optical axis. In particular, astigmatic aberration and geometric distortions cause distortions of the image reaching the wearer's retina. Moreover, progressive lenses need to be carefully fitted to the wearer's eye position to avoid a narrow field of view, on-axis blur and only one-eyed clear vision. Most importantly, due to high manufacturing costs and the professional service costs incurring from the need for perfect fitting of the lens, progressive lenses are far more expensive than single-vision lenses providing only a single optical power, but also than segmented multifocal lenses.

In both, conventional multifocal lenses nor progressive multifocal lenses, the part of the lens fitted for near-vision has a limited width that does not cover the whole width of the lens. It is therefore a drawback of current conventional and progressive multifocal lenses that the wearer has to move the head when viewing in the near-vision range such that the object of vision can be viewed through the near-vision part of the lens. In particular, dynamic movement of the eye is limited to the width of the near-vision part of the lens and has to be compensated for by movements of the head when extending beyond the thus obtainable vision field. This is particular detrimental in reading as it prevents the wearer from simply scanning the text with the eyes.

### SUMMARY

It is therefore a purpose of the present invention to provide an easy-to-personalize multifocal lens that minimizes dynamical blurs and can be provided at reduced manufacturing time and cost.

This object is accomplished according to the present invention by a multifocal lens, in particular an ophthalmic multifocal lens, being built in an inkjet printing process of depositing droplets of printing ink side by side and one above the other in several consecutive depositing steps and curing them in intermediate curing steps, wherein the multifocal lens comprises a first section providing a first optical function and a second section providing a second optical function that differs from the first optical function.

In the sense of the present invention, printing an optical lens is carried out by depositing droplets of printing ink side by side and one above the other in several consecutive depositing steps by means of a print head, wherein in each depositing step a plurality of droplets is ejected simultaneously by a plurality of ejection nozzles of the print head. As known from the prior art, the deposited droplets are at least partly cured after each depositing step in a curing step. The printing ink of the deposited droplets is either fully cured after each depositing step or only partly cured.

The printing ink comprises preferably transparent or translucent printing ink. Preferably, the printing ink comprises an UV curable liquid monomer becoming a polymer if being cured. Preferably, the droplets are deposited onto a substrate. The substrate can be a part of the printed optical lens or a support plate for supporting the deposited droplets only during the printing process.

A multifocal lens in the sense of the present invention is a lens with at least two different focal lengths. In particular, a multifocal lens in the sense of the present invention is a non-progressive lens. A multifocal ophthalmic lens in the sense of the present invention is a multifocal lens that corrects defective vision in humans. Multifocal ophthalmic lenses in the sense of the present invention comprise multifocal intraocular lenses, multifocal contact lenses and multifocal corrective lenses.

Multifocal corrective lenses are multifocal lenses made for implementation in eyeglass frames, monocles and similar ophthalmic devices wherein the ophthalmic devices are worn in such a way that they are not in direct contact with the human eye.

Lenses in the sense of the present invention are optical lenses and preferably comprise spherical lenses wherein a spherical lens is characterized in that two opposite surfaces of the lens are parts of the surfaces of spheres. Spherical lenses in particular comprise biconvex lenses, planoconvex lenses, planoconcave lenses, biconcave lenses and convex-concave (meniscus) lenses. The spheres and their respective surfaces are characterized by their respective radius of curvature. The radius of curvature of the lens surface closest to the human eye when the lens is worn as part of an ophthalmic means is referred to as the inner radius of curvature. The radius of curvature of the lens surface farthest from the human eye when the lens is worn as part of an ophthalmic means is referred to as the outer radius of curvature. Lenses in the sense of the present invention also preferably comprise aspherical optical lenses. Lenses in the sense of the present invention likewise comprise lenses used for the correction of astigmatism, such as toric and atoric lenses.

Here and in the following, the surface of the optical component that intersects the axis of sight and is located farthest from the human eye when the optical component is worn as part of an ophthalmic means is referred to as outer surface. The surface of the optical component that intersects the axis of sight and is located closest to the human eye when the optical component is worn as part of an ophthalmic means is referred to as inner surface. All surfaces of the optical component that are neither front surface nor back surface are referred to as rim of the lens.

An optical function of an optical lens in the sense of the present invention comprises the lens power. The lens power or optical power of the lens is measured in diopters and defined as the inverse of the focal length in meters. The focal length of an optical component is determined by
the refractive index of the optical component,
the thickness of the optical component measured as the distance along the optical axis of the optical component between the intersection point of the inner surface with the optical axis and the intersection point of the outer surface with the optical axis and
the radius of curvature of the inner surfaces of the optical component and the radius of curvature of the outer surface of the optical component.

The optical axis of a lens is the line joining the centers of the spheres that make up the lens surfaces.

A section of a lens in the sense of the present invention is a connected part of the lens comprising at least part of the inner lens surface and at least part of the outer lens surface. In the sense of the present invention, the lens comprises a first and a second section. The first section comprises a first inner surface, a first outer surface and a first border. The second section comprises a second inner surface, a second outer surface and a second border.

In a preferred embodiment of the present invention, the optical lens comprises a first section providing a first optical power and a second section providing a second optical power wherein the second optical power differs from the first optical power. In particular, the first optical power may be higher than the second optical power. Alternatively, the first optical power may be lower than the second optical power.

It is conceivable that the first section has a first refractive index and the second section has a second refractive index differing from the first refractive index. In particular, the first refractive index may be higher than the second refraction index. Alternatively, the first refractive index may be lower than the second refractive index.

It is conceivable that the first section is made up of a first printing ink and the second section is made up of a second printing ink differing from the first printing ink. In particular, the first printing ink may differ from the second printing ink in at least one physical parameter, wherein the physical parameters preferably comprise curing time, curing temperature, curing wavelength, viscosity, transmittance and/or optical transparency. It is conceivable that the first section has been cured during a first curing step with first curing specifications and the second section has been cured during a second curing step with second curing specifications differing from the first curing specifications. In particular, the first curing specifications may differ from the second curing specifications in at least one specification, wherein the specifications preferably comprise curing time, curing temperature, curing wavelength and curing intensity. In the terminology ‘first curing step’ and ‘second curing step’ the attributes ‘first’ and ‘second’ do not refer to a chronological order in which the curing steps are carried out, but refer to the section on which the curing step is carried out. It is also conceivable that the first section comprises a first inner surface with a first inner radius of curvature and a first outer surface with a first outer radius of curvature and the second section comprises a second inner surface with a second inner radius of curvature and a second outer surface with a second outer radius of curvature. In particular, the first inner radius of curvature may differ from the second inner radius of curvature and/or the first outer radius of curvature may differ from the second outer radius of curvature.

It is also conceivable that the first section has a first optical axis and the second section has a second optical axis that differs from the first optical axis. It is conceivable that the first section has a first thickness measured as the distance along the first optical axis between the intersection points of the first inner surface and the first outer surface with the first optical axis, and the second section has a second thickness measured as the distance along the second optical axis between the intersection points of the second inner surface and the second outer surface with the second optical axis wherein the second thickness differs from the first thickness. In particular, the first section may be thicker than the second section. Alternatively, the first section may be thinner than the second section.

It is conceivable that a lens with two sections differing in at least one optical function is achieved through any combination of any number of the aforementioned possibilities, namely differing refractive index of the two sections, differing printing ink used in printing the two sections, differing inner radius of curvature of the two sections, differing outer radius of curvature of the two sections, differing optical axis of the two sections and differing thickness of the two sections.

According to a preferred embodiment of the present invention, the multifocal lens comprises a transition zone being located between the first section and the second section.

The part of the lens located between the first section and the second section is referred to as transition zone. In particular, the transition zone has no optical function but constitutes an intermediate regime interpolating between the first and the second section.

In particular, the thickness of the transition zone at the interface of transition zone and first section is equal to the thickness of the first section and the thickness of the transition zone at the interface of transition zone and second section is equal to the thickness of the second section.

It is conceivable that the thickness of the transition zone between the interface of the transition zone with the first section and the interface of the transition zone with the second section smoothly changes from the thickness of the first section to the thickness of the second section when going from the interface of the transition zone with the first section to the interface of the transition zone with the second section.

In a preferred embodiment of the present invention, the transition zone is reduced to the area of the lens at which the first section and the second section are in direct contact with each other. In particular, the transition from the first optical function of the first section to the second optical function of the second section is discontinuous and abrupt.

The transition zone comprises a transition zone inner surface, a transition zone outer surface and a transition zone border.

It is also conceivable that the transition zone constitutes an interface between a first type of material making up the first section, in particular a first printing ink from which the first section has been printed, and a second type of material making up the second section, in particular a second printing ink from which the second section has been printed.

It is conceivable that the transition zone border comprises part of the rim of the optical lens. The part of the transition zone border that is comprised in the rim of the optical lens, is referred to as transition zone rim.

It is alternatively conceivable that the transition zone border does not comprise part of the rim of the optical lens. In particular, the transition zone border lies completely inside the lens. Preferably, the first section is on all sides surrounded by the second section. In particular, the transition zone may be 0-shaped or circular or D-shaped.

According to another preferred embodiment of the present invention, the transition zone extends substantially straight or curved from a first rim area of the transition zone to a second rim area of the transition zone of the multifocal lens.

In a preferred embodiment of the present invention, the rim of the transition zone is not connected. In particular, the rim of the transition zone consists of a first part which is referred to as first rim area and a second part which is referred to as second rim area wherein the first rim area is not in contact with the second rim area.

In a preferred embodiment of the present invention, the transition zone extends straight from the first rim area to the second rim area. In particular, the transition zone may be I-shaped. In practice, however, a strictly straight transition zone may be hard to realize. In particular, irregularities in the printing process, e.g. the melting of droplets of printing ink and/or imprecisely deposited printing ink and/or insufficient curing of the deposited droplets may cause deviations from a strictly straight transition zone. Consequently, the transition zone may be slightly curved due to small deviations from the intentionally straight form.

In an alternative embodiment of the present invention, the transition zone extends substantially straight from the first rim area to the second rim area.

In an alternative embodiment of the present invention, the transition zone extends curved from the first rim area to the second rim area. In particular, the transition zone may be C-shaped or the transition zone may be S-shaped or the transition zone may be U-shaped or the transition zone may be any interpolation between or combination of C-, U- and S-shape.

According to another preferred embodiment of the present invention, the first section is located in an upper part of the multifocal lens, wherein the second section is located in a lower part of the multifocal lens and wherein the transition zone is located in a middle part between the upper part and the lower part of the multifocal lens.

In the sense of the present invention, ‘upper’ and ‘lower’ are defined by the orientation of the lens under wearing conditions, i.e. the upper part is the cranial part of the lens and the lower part is the caudal part of the lens. The middle part of the lens is the part of the lens that is located between upper and lower part of the lens.

The ratio between the area of the front surface of the upper part, the area of the inner surface of the middle and the area of the inner surface of the lower part may take any value. In particular, the area of the inner surface of the upper part may be larger than the area of the inner surface of the lower part which in turn may be larger than the area of the inner surface of the middle part.

The ratio between the area of the outer surface of the upper part, the area of the outer surface of the middle and the area of the outer surface of the lower part may take any value. In particular, the area of the outer surface of the upper part may be larger than the area of the outer surface of the lower part which in turn may be larger than the area of the outer surface of the middle part.

Preferably, the first section is located in the upper part of the lens and extends over the full width of the lens. Preferably, the second section is located in the lower part of the lens and extends over the full width of the lens.

It is herewith advantageously possible to provide a multifocal lens with minimal dynamical blur. In particular, both sections extend over the full width of the lens, reducing adjustment of the vision field through movements of the head to a minimum.

In a preferred embodiment of the present invention, the upper part of the lens has a first optical power determined by the wearer's distance vision and the lower part has a second optical power determined by the wearer's near vision.

According to another preferred embodiment of the present invention, the multifocal lens comprises a kink located on at least one surface of the transition zone, wherein the kink preferably takes the form of a step.

In a preferred embodiment of the present invention, the inner surface of the transition zone comprises a kink. In particular, the kink is the structure on the inner surface arising through the transition of the first inner radius of curvature to the second inner radius of curvature and/or arising through the transition from the first thickness to the second thickness.

In a preferred embodiment of the present invention, the kink takes the form of a step from the first inner surface to the second inner surface, i.e. in the sense of the present invention that the height falls sharply from the height of the first inner surface to the height of the second inner surface. In an alternative embodiment of the present invention, the kink takes the form of a step from the second inner surface to the first inner surface, i.e. in the sense of the present invention that the height falls sharply from the height of the second inner surface to the height of the first inner surface.

In another preferred embodiment of the present invention, the outer surface of the transition zone comprises a kink. In particular, the kink is the structure on the outer surface arising through the transition of the first outer radius of curvature to the second outer radius of curvature and/or arising through the transition from the first thickness to the second thickness. In a preferred embodiment of the present invention, the kink takes the form of a step from the first outer surface to the second outer surface, i.e. in the sense of the present invention that the height falls sharply from the height of the first outer surface to the height of the second outer surface. In an alternative embodiment of the present invention, the kink takes the form of a step from the second outer surface to the first outer surface, i.e. in the sense of the present invention that the height falls sharply from the height of the second outer surface to the height of the first outer surface.

In a preferred embodiment of the present invention, the first outer surface is convex and the second outer surface is convex, and the inner first surface is concave and the inner second surface is concave. Preferably, the first inner radius of curvature coincides with the second inner radius of curvature. In particular, the transition zone comprises a kink located on the outer surface. In particular, the transition zone comprises only one kink. In particular the kink is located on the outer surface.

According to another preferred embodiment of the present invention, the kink extends substantially straight or curved from one rim area to the another rim area of the multifocal lens.

Preferably, the kink essentially follows the transition zone.

In a preferred embodiment of the present invention, if the transition zone extends substantially straight from the first rim area of the transition zone to the second rim area of the transition zone of the multifocal lens, the kink also extends substantially straight from the first rim area to the second rim area of the transition zone of the multifocal lens.

In a preferred embodiment of the present invention, if the transition zone extends curved from the first rim area of the transition zone to the second rim area of the transition zone of the multifocal lens, the kink also extends curved from the first rim area to the second rim area of the transition zone of the multifocal lens.

According to another preferred embodiment of the present invention, the step is sharp-edged having a curve radius lower than 1 Millimeter, preferably lower than 100 Micrometer, particularly preferably lower than 10 Micrometer and most particularly preferably lower than 1 Micrometer.

According to another preferred embodiment of the present invention, the first section comprises a lens material having a first refractive index and wherein the second section comprises a lens material having a second refractive index that differs from the first refractive index.

Preferably lens material comprises printing ink. The printing ink comprises preferably transparent or trans-lucent printing ink. Preferably, the printing ink comprises an UV curable liquid monomer becoming a polymer if being cured.

In a preferred embodiment of the present invention, the first section is being generated from a first printing ink and the second section is being generated from a second printing ink, wherein the second printing ink differs from the first printing ink in at least one physical parameter, wherein the physical parameters preferably comprise curing time, curing temperature, curing wavelength, refractive index, viscosity, transmittance, absorption properties, electromagnetic properties and/or optical transparency. It is herewith advantageously possible to print the first section with the first set of physical properties and the second section with a second set of physical properties. In particular, the first section may have a first refractive index and the second section has a second refractive index.

According to another preferred embodiment of the present invention the curing step is performed in such a manner that the deposited droplets of the first section are exposed to UV light with an exposure time, and intensity and/or a wavelength range differing from exposure time, intensity and/or wavelength range the deposited droplets of the second section are exposed to.

Exposure to UV light alters the refractive index of the deposited droplets of printing ink. Preferably exposure to UV light may be used to modify the optical properties of the first section, e.g. the refractive index of the first section depends on the exposure time, intensity and/or wavelength range of UV light that the first section is exposed to during the curing step. Preferably exposure to UV light may be used to modify the optical properties of the second section, e.g. the refractive index of the second section depends on the exposure time, intensity and/or wavelength range of UV light that the second section is exposed to during the curing step.

It is herewith advantageously possible to cure the first section with a first exposure time, a first intensity and/or a first wavelength range and the second section with a second exposure time, a second intensity and/or a second wavelength range. For example, the first section may be printed using a first printing ink with a first set of physical properties, necessitating curing with an UV light of a first exposure time, a first intensity and/or a first wavelength range. The second section may be printed using a second printing ink with a second set of physical properties, necessitating curing with an UV light of a second exposure time, a second intensity and/or a second wavelength range. In particular, the first section may have a first refractive index and second section may have a second refractive index differing from the first refractive index.

According to another preferred embodiment of the present invention, the multifocal lens comprises a third section providing a third optical function, wherein the second section is located between the first section and the third section and wherein a further transition zone is located between the second section and the third section.

In a preferred embodiment of the present invention the lens comprises a first, a second and a third section.

The third section comprises a third inner surface, a third outer surface and a third border. The second section comprises a second inner surface, a second outer surface and a second border.

In a preferred embodiment of the present invention, the optical lens comprises a first section providing a first optical power, a second section providing a second optical power and a third section providing a third optical power wherein the second optical power differs from the first optical power, wherein the third optical power differs from the second optical power. Preferably, the third optical power differs from the first optical power.

It is conceivable that the first section has a first refractive index, the second section has a second refractive index differing from the first refractive index and the third section has a third refractive index differing from the second refractive index. Preferably, the third refractive index differs from the first refractive index.

It is conceivable that the first section is made up of a first printing ink, the second section is made up of a second printing ink differing from the first printing ink and the third section is made up of a third printing ink differing from the second printing ink. Preferably, the third printing ink differs from the first printing ink. In particular, the first printing ink may differ from the second printing ink in at least one physical parameter. In particular, the first printing ink may differ from the third printing ink in at least one physical parameter. In particular, the second printing ink may differ from the third printing ink in at least one physical parameter. The physical parameters preferably comprise curing time, curing temperature, curing wavelength, viscosity, transmittance and/or optical transparency.

It is conceivable that the first section has been cured during a first curing step with first curing specifications, the second section has been cured during a second curing step with second curing specifications differing from the first curing specifications and the third section has been cured during a third curing step with third curing specifications differing from the second curing specifications. Preferably, the third curing specifications differ from the first curing specifications. In particular, the first curing specifications may differ from the second curing specifications in at least one specification. In particular, the first curing specifications may differ from the third curing specifications in at least one specification. In particular, the second curing specifications may differ from the third curing specifications in at least one specification. The specifications preferably comprise curing time, curing temperature, curing wavelength and curing intensity. In the terminology ‘first curing step’, ‘second curing step’, . . . the attributes ‘first’, ‘second’, . . . do not refer to a chronological order in which the curing steps are carried out, but refer to the section on which the curing step is carried out.

It is also conceivable that the first section comprises a first inner surfaces with a first inner radius of curvature and a first outer surface with a first outer radius of curvature, the second section comprises a second inner surfaces with a second inner radius of curvature and a second outer surface with a second outer radius of curvature and the third section comprises a third inner surfaces with a third inner radius of curvature and a third outer surface with a third outer radius of curvature. In particular, the first inner radius of curvature may differ from the second inner radius of curvature and/or the first inner radius of curvature may differ from the third inner radius of curvature and/or the second inner radius of curvature may differ from the third inner radius of curvature and/or the first outer radius of curvature may differ from the second outer radius of curvature and/or the first outer radius of curvature may differ from the third outer radius of curvature and/or the second outer radius of curvature may differ from the third outer radius of curvature.

It is also conceivable that the first section has a first optical axis, the second section has a second optical axis that differs from the first optical axis and the third section has a third optical axis that differs from the second optical axis. Preferably the third optical axis differs from the first optical axis.

It is conceivable that the first section has a first thickness measured as the distance along the first optical axis between the intersection points of the first inner surface and the first outer surface with the first optical axis, the second section has a second thickness measured as the distance along the second optical axis between the intersection points of the second inner surface and the second outer surface with the second optical axis wherein the second thickness differs from the first thickness, and the third section has a third thickness measured as the distance along the third optical axis between the intersection points of the third inner surface and the third outer surface with the third optical axis wherein the third thickness differs from the second thickness. Preferably the third thickness differs from the first thickness.

It is conceivable that a lens with three sections differing in at least one optical function is achieved through any combination of any number of the aforementioned possibilities, namely differing refractive index of the three sections, differing printing ink used in printing the three sections, differing inner radius of curvature of the three sections, differing outer radius of curvature of the three sections, differing optical axis of the three sections and differing thickness of the three sections.

In a preferred embodiment of the present invention the first section is located in an upper part of the multifocal lens, the second section is located in a middle part of the multifocal lens and the third section is located in a lower part of the multifocal lens. The transition zone is located between the first and the second section and the further transition zone is located between the second and the third section. Preferably the first optical power is determined by the wearer's distance vision, the third optical power is determined by the wearer's near vision and the third optical power is determined by the wearer's intermediate vision, wherein the intermediate visual range is e.g. the vision range required for computer work.

Another object of the present invention is a method for printing a multifocal lens, in particular an ophthalmic multifocal lens according to one of the preceding claims, by depositing droplets of printing ink side by side and one above the other in several consecutive depositing steps and curing them in intermediate curing steps, wherein the depositing and curing steps are performed in such a manner that the multifocal lens is built up such that a first section of the multifocal lens provides a first optical function and a second section of the multifocal lens provides a second optical function differing from the first optical function.

In a preferred embodiment of the present invention, the ophthalmic lens is being built up successively by depositing droplets of printing ink side by side and one above the other by means of a print head in several consecutive depositing steps, wherein in each depositing step a plurality of droplets is ejected simultaneously by a plurality of ejection nozzles of the print head, wherein after at least one depositing step the droplets are cured in an intermediate curing step. Over the repeated depositing steps, the three-dimensional structure of the ophthalmic lens is being built up layer by layer. Preferably, the droplets are deposited onto a substrate. The substrate can be a part of the printed structure or a support plate for supporting the deposited droplets only during the printing process.

The printing data are provided to the printer be means of an intensity image. The intensity image preferably comprises a two-dimensional pattern of different grey or colour intensities. The pattern consists of different pixels, wherein each pixel represents a certain position in the three-dimensional ophthalmic lens to be printed. In particular, each pixel represents a certain position of a two-dimensional projection of the three-dimensional ophthalmic lens onto a flat base plane. The distribution of the intensity in the intensity image represents the shape of the three-dimensional ophthalmic lens to be printed as the intensity in each pixel is a value for the height of the three-dimensional ophthalmic lens at the corresponding position. The height of the printed three-dimensional ophthalmic lens in a certain position depends on the number/size of droplets of printing ink and accordingly to the amount of printing material deposited in this position. The print head deposits printing ink in dependency of the intensity image, so that a three-dimensional ophthalmic lens is printed having the shape of the software based-virtual design given by the intensity image.

In a preferred embodiment of the present invention, during each depositing step, droplets of a first printing ink and droplets of a second printing ink are deposited side by side and one above the other by means of the print head, wherein a first set of ejection nozzles ejects droplets of the first printing ink on one part of the substrate and/or on one part of the pre-structure and a second set of ejection nozzles ejects droplets of the second printing ink on the other part of the substrate and/or the other part of the pre-structure. It is herewith advantageously possible to provide an ophthalmic lens with a first section made up of a first printing ink and a second section made up of a second printing ink, wherein the first printing ink differs from the second printing ink in at least one physical parameter, wherein the physical parameters preferably comprise curing time, curing temperature, curing wavelength, viscosity, transmittance and/or optical transparency.

It is alternatively conceivable that droplets of the first printing ink are deposited side by side and one above the other by means of the print head in a first depositing step, wherein in each first depositing step a plurality of droplets of the first printing ink is ejected simultaneously by a plurality of ejection nozzles of the print head on one part of the substrate and/or on one part of the pre-structure to build up a first section of the ophthalmic lens and droplets of the second printing ink are deposited side by side and one above the other by means of the print head in a second depositing step, wherein in each second depositing step a plurality of droplets of the second printing ink is ejected simultaneously by a plurality of ejection nozzles of the print head on the other part of the substrate and/or the other part of the pre-structure to build up a second section of the ophthalmic lens.

In another preferred embodiment of the present invention, during each depositing step, droplets of printing ink are deposited side by side and one above the other by means of the print head, wherein a first set of ejection nozzles ejects droplets of a first volume and/or a first number of droplets on one part of the substrate and/or on one part of the pre-structure to build up a first section of the ophthalmic lens and a second set of ejection nozzles ejects droplets of a second volume and/or a second number of droplets on the other part of the substrate and/or the other part of the pre-structure to build up a second section of the ophthalmic lens. In an alternative preferred embodiment of the present invention, the first set of ejection nozzles deposits a first number of layers of printing ink to build up a first section of the ophthalmic lens and the second set of ejection nozzles deposits a second number of layers of printing ink to build up a second section of the ophthalmic lens.

In an alternative preferred embodiment of the present invention, during each depositing step, droplets of printing ink are deposited side by side and one above the other by means of the print head, wherein droplets of a first volume and/or a first number of droplets are deposited on one part of the substrate and/or on one part of the pre-structure to build up a first section of the ophthalmic lens and droplets of a second volume and/or a second number of droplets are deposited on the other part of the substrate and/or the other part of the pre-structure to build up a second section of the ophthalmic lens. In an alternative preferred embodiment of the present invention, the ejection nozzles deposit a first number of layers of printing ink on one part of the substrate and/or on one part of the pre-structure to build up a first section of the ophthalmic lens and the ejection nozzles deposit a second number of layers of printing ink on the other part of the substrate and/or the other part of the pre-structure to build up a second section of the ophthalmic lens.

It is herewith advantageously possible to provide an ophthalmic lens with a first section comprising a first thickness and a second section comprising a second thickness.

In another preferred embodiment of the present invention, during each depositing step, droplets of printing ink are deposited side by side and one above the other by means of the print head such to provide a first section with a first inner surface and a first outer surface, wherein preferably the first inner surface comprises a first inner radius of curvature and the first outer surface comprises a first outer radius of curvature and a second section with a second inner surface and a second outer surface, wherein preferably the second inner surface comprises a second inner radius of curvature and the second outer surface comprises a second outer radius of curvature.

Preferably, the ophthalmic lens is printed on a substrate. Preferably, the substrate provides a first radius of curvature on a first section of its surface and a second radius of curvature on a second section of its surface. It is conceivable that the first radius of curvature of the first section of the substrate's surface provides the first inner radius of curvature of the ophthalmic lens and the second radius of curvature of the second section of the substrate's surface provides the second inner radius of curvature of the ophthalmic lens. Alternatively, it is conceivable that the first radius of curvature of the first section of the substrate's surface provides the first outer radius of curvature of the ophthalmic lens and the second radius of curvature of the second section of the substrate's surface provides the second outer radius of curvature of the ophthalmic lens.

In a preferred embodiment of the present invention, the droplets of printing ink are cured in a curing step. Preferably, a first section of the ophthalmic lens is being cured with UV light of a first curing specification and a second section of the ophthalmic lens is being cured with UV light of a second curing specification differing from the first curing specification. The curing specifications preferably comprise curing time, curing temperature, curing wavelength and curing intensity. In the terminology ‘first curing specification’, ‘second curing specification’, . . . the attributes ‘first’, ‘second’, . . . do not refer to a chronological order in which the curing is carried out, but refer to the section on which the curing is carried out.

Preferably, the first section of the ophthalmic lens is being cured with UV light of a first curing specification in a first curing step and second section of the ophthalmic lens is being cured with UV light of a second curing specification in a second curing step. It is conceivable that in the first curing step curing is performed with a first UV light and in the second curing step curing is performed with a second UV light, wherein the second UV light emit UV light of an intensity, an exposure time and/or wavelength range differing from the intensity, exposure time and/or wavelength range of the first UV light. It is alternatively conceivable that curing of the first section is carried out with the same UV light as curing of the second section and the curing specification is switched from the first curing specification applied in the curing of the first section to the second curing specification in the curing of the second section.

It is alternatively conceivable that the intermediate curing step is performed with a UV light source that emits UV light of differing intensity and/or with differing exposure time and/or wavelength at at least two different points on the pre-structure resulting in an a spatially varying exposure of the pre-structure to UV light.

In a preferred embodiment of the present invention, the first section is cured with a UV light of a first curing specification providing the first section with a first refractive index and the second section is cured with a UV light of a second curing specification providing the second section with a second refractive index.

It is herewith advantageously possible to provide an ophthalmic lens comprising a first section providing a first refractive index and a second section providing a second refractive index.

According to a preferred embodiment of the present invention, a transition zone located between the first section and the second section and extending substantially straight or curved from one rim area to the another rim area of the multifocal lens is built up during the depositing and curing steps, wherein the multifocal lens is built up in such a manner that the transition zone comprises a kink located on at least one surface of the transition zone, wherein the kink preferably takes the form of a step.

The ophthalmic lens is built up from layers of printing ink by depositing droplets of printing ink side by side and one above the other on a substrate and/or pre-structure, wherein after at least one depositing step the deposited droplets are at least partially cured in an intermediate curing step.

In a preferred embodiment of the present invention, the ophthalmic lens is provided with a first section comprising a first optical function and a second section comprising a second optical function. In particular, the ophthalmic lens is provided with a first section comprising a first optical power and a second section comprising a second optical power.

In a preferred embodiment, the ophthalmic lens is provided with a first section comprising a first thickness and a second section comprising a second thickness. In particular, the number of layers of printing ink deposited on the first section of the substrate and/or on the first section of the pre-structure differs from the number of layers of printing ink deposited on the second section of the substrate and/or on the second section of the pre-structure.

In particular, in the depositing steps following the depositing step at which the number of layers of the first section equals the number of layers of the second section, a kink begins to form at the interface between the first and the second section. In a preferred embodiment of the present invention, the kink takes the form of a step.

It is also conceivable that the number of droplets of printing ink and/or the volume of the droplets of printing ink deposited on the first section of the substrate and/or on the first section of the pre-structure in each depositing step differs from the number of droplets of printing ink and/or the volume of the droplets of printing ink deposited on the second section of the substrate and/or on the second section of the pre-structure in each depositing step. In each depositing step, a kink arises at the interface between the first and the second section as a result of the differing thickness of the first and the second section. In a preferred embodiment of the present invention, the kink takes the form of a step.

In a preferred embodiment of the present invention, the droplets of printing ink are deposited on the first section of the substrate and/or the first section of the pre-structure providing a first section of the ophthalmic lens with a first outer radius of curvature and on the second section of the substrate and/or the second section of the pre-structure providing a second section of the ophthalmic lens with a second outer radius of curvature. At the interface of the first section and the second section, a kink arises as a consequence of the transition from the first outer radius of curvature to the second outer radius of curvature. In a preferred embodiment of the present invention, the kink is printed as a step from the first to the second section or as a step from the second to the first section.

Preferably, the inner surface of the ophthalmic lens is printed on a substrate, wherein the substrate takes the form of a part of the surface of a sphere. Depositing droplets of printing ink on the substrate with a certain radius of curvature provides an optical lens with an outer surface with an outer radius of curvature wherein the outer radius of curvature equals the certain radius of curvature of the substrate.

According to another preferred embodiment of the present invention, the depositing steps are performed in such a manner that droplets deposited in the area of the kink have a reduced size in order to build up a sharp-edged kink having preferably a curve radius lower than 1 Millimeter, particularly preferably lower than 100 Micrometer, more particularly preferably lower than 10 Micrometer and most particularly preferably lower than 1 Micrometer.

In a preferred embodiment of the present invention, the kink is printed as a step from the first section to the second section or as a step from the second to the first section. Preferably, the step has a curve radius lower than 1 Millimeter, particularly preferably lower than 100 Micrometer, more particularly preferably lower than 10 Micrometer and most particularly preferably lower than 1 Micrometer.

Preferably, the volume of the droplets of printing ink deposited on the interface between the first section and the second section is reduced as compared to the volume of the droplets of printing ink deposited on the remaining part of the substrate and/or pre-structure.

In another preferred embodiment of the present invention, at the interface between the first section and the second section droplets of a transition printing ink are deposited during the depositing steps, wherein the transition printing ink differs from the first printing ink and the second printing ink in at least one physical parameter. Preferably, the transition printing ink has a higher viscosity than the first printing ink and the second printing ink.

It is herewith advantageously possible to provide the ophthalmic lens with a sharp-edged kink constituting the transition from the first section to the second section. In particular, it is herewith advantageously possible to provide the ophthalmic lens with a sharp-edged step constituting the transition from the first section to the second section.

In another preferred embodiment of the present invention, an instant curing step is carried out immediately after droplets of transition printing ink are deposited. It is herewith advantageously possible to prevent melting away and smearing of the deposited droplets of transition printing ink providing a sharp-edged kink, preferably a sharp-edged step, at the interface between first and second section.

According to another preferred embodiment of the present invention, the curing steps are performed in such a manner that droplets deposited in the area of the kink have a reduced curing time in order to build up a sharp-edged kink having preferably a curve radius lower than 1 Millimeter, particularly preferably lower than 100 Micrometer, more particularly preferably lower than 10 Micrometer and most particularly preferably lower than 1 Micrometer.

In another preferred embodiment of the present invention, at the interface between the first section and the second section droplets of a transition printing ink are deposited during the depositing steps, wherein the transition printing ink differs from the first printing ink and the second printing ink in at least one physical parameter. Preferably, the transition printing ink has a shorter curing time than the first printing ink and the second printing ink. It is herewith advantageously possible to prevent melting away and smearing of the deposited droplets of transition printing ink. Herewith, a sharp-edged kink, preferably a sharp-edged step, is provided at the interface between first and second section. According to another preferred embodiment of the present invention, the curing steps are performed in such a manner that deposited droplets in the first section are exposed to UV light with different intensity, wavelength or exposure time compared to deposited droplets in the second section in order to achieve different refractive indices in the first section and the second section. In a preferred embodiment of the present invention, the droplets of printing ink are cured in a curing step. Preferably, a first section of the ophthalmic lens is being cured with UV light of a first curing specification and a second section of the ophthalmic lens is being cured with UV light of a second curing specification differing from the first curing specification. The curing specifications preferably comprise curing time, curing temperature, curing wavelength and curing intensity. In the terminology ‘first curing specification’, ‘second curing specification’, . . . the attributes ‘first’, ‘second’, . . . do not refer to a chronological order in which the curing is carried out, but refer to the section on which the curing is carried out. Preferably, the first section of the ophthalmic lens is being cured with UV light of a first curing specification in a first curing step and second section of the ophthalmic lens is being cured with UV light of a second curing specification in a second curing step. It is conceivable that in the first curing step curing is performed with a first UV light and in the second curing step curing is performed with a second UV light, wherein the second UV light emit UV light of an intensity, an exposure time and/or wavelength range differing from the intensity, exposure time and/or wavelength range of the first UV light. It is alternatively conceivable that curing of the first section is carried out with the same UV light as curing of the second section and the curing specification is switched from the first curing specification applied in the curing of the first section to the second curing specification in the curing of the second section.

It is alternatively conceivable that the intermediate curing step is performed with a UV light source that emits UV light of differing intensity and/or with differing exposure time and/or wavelength at at least two different points on the pre-structure resulting in an a spatially varying exposure of the pre-structure to UV light.

In a preferred embodiment of the present invention, the first section is cured with a UV light of a first curing specification providing the first section with a first refractive index and the second section is cured with a UV light of a second curing specification providing the second section with a second refractive index.

It is herewith advantageously possible to print an ophthalmic lens comprising a first section providing a first refractive index and a second section providing a second refractive index.

According to another preferred embodiment of the present invention, the depositing and curing steps are performed in such a manner that the multifocal lens has further a third section providing a third optical function, wherein the second section is located between the first section and the third section and wherein a further transition zone is located between the second section and the third section.

The printing process described above for an ophthalmic lens comprising a first section with a first optical function and a second section with a second optical function can be generalized to a printing process for an ophthalmic lens comprising a first section with a first optical function, a second section with a second optical function and a third section with a third optical function by carrying out the depositing steps and curing steps on the third section as compared to the depositing steps and curing steps on the first and second section analogously to the depositing steps and curing steps on the second section as compared to the depositing steps and curing steps on the first section, e.g. by depositing droplets of a third printing ink on a third section of the substrate and/or a third section of the pre-structure, wherein the third printing ink differs from the first printing ink and the second printing ink in at least one physical parameter and/or by using UV light with a third curing specification wherein the third curing specification differs from the first curing specification and the second curing specification in at least one specification, etc.

It is herewith advantageously possible to print an ophthalmic lens with three sections, wherein each section has a different optical power. In particular, it is herewith advantageously possible to print an ophthalmic lens with a first section providing an optical power determined by the wearer's distance vision in the upper part of the lens, a second section providing an optical power determined by the wearer's intermediate-distance vision, e.g. for computer work, in the middle part of the lens and a third section providing an optical power determined by the wearer's near vision in the lower part of the lens.

### BRIEF DESCRIPTION OF THE DRAWINGS

FIG. 1 illustrates schematically a multifocal lens providing two optical functions and a sharp-edged step located on the transition zone according to an exemplary embodiment of the present invention.

FIG. 2 illustrates schematically a multifocal lens providing two optical functions and a transition zone according to an exemplary embodiment of the present invention.

### DETAILED DESCRIPTION

The present invention will be described with respect to particular embodiments and with target to certain drawings but the invention is not limited thereto but only by the claims. The drawings described are only schematic and are non-limiting. In the drawings, the size of some of the elements may be exaggerated and for illustrative purposes may not be drawn to scale.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

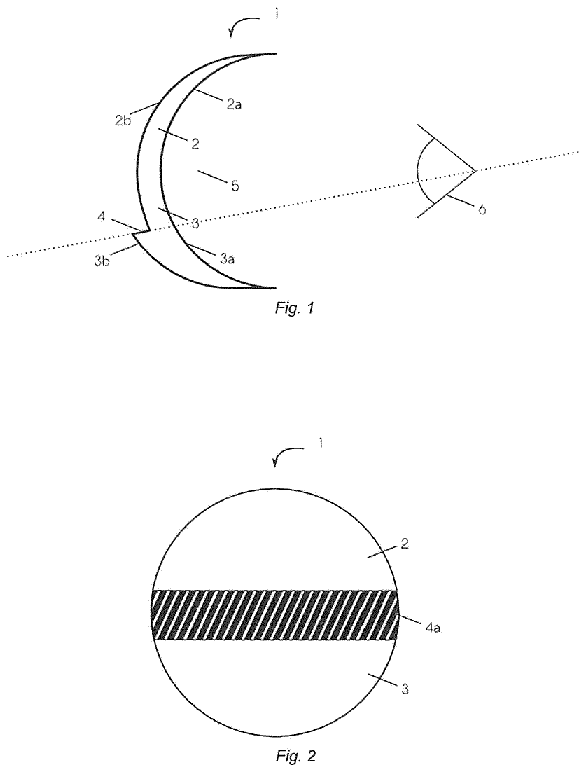

In FIG. 1, a multifocal lens 1 is schematically illustrated. In the present example, the multifocal lens 1 comprises a first section 2 and a second section 3. The first section 2 is located in the upper part of the lens, the second section 3 is located in the lower part of the multifocal lens 1. The first section 2 comprises a first inner surface 2a with a first inner radius of curvature and a first outer surface 2b with a first outer radius of curvature. In the present example, the first section is convex-concave. The second section 3 comprises a second inner surface 3a with a first inner radius of curvature and a second outer surface 3b with a second outer radius of curvature. In the present example, the second section is convex-concave. The first inner radius of curvature of the first inner surface 2a coincides with the second inner radius of curvature of the second inner surface 3a. The first outer radius of curvature of the first outer surface 2b preferably coincides with the second outer radius of curvature of the second outer surface 3b. The first section 2 comprises a first thickness and the second section 3 comprises a second thickness that differs from the first thickness. As a result, the transition zone 4a comprises a kink 4 which takes the form of a sharp-edged step. In the present example, the kink 4 lies exactly in the axis of sight 5. It is herewith advantageously possible to provide a multifocal ophthalmic lens 1 without peripheral and/or on-axis blurs.

In FIG. 2, a multifocal lens 1 is schematically illustrated. In the present example, the multifocal lens 1 comprises a first section 2 and a second section 3. The first section 2 is located in the upper part of the lens, the second section 3 is located in the lower part of the multifocal lens 1. Between the first section 2 and the second section 3, the multifocal lens 1 comprises a transition zone 4a.

### KEY TO FIGURES

1 Multifocal lens

2 First section

2a First inner surface

2b First outer surface

3 Second section

3a Second inner surface

3b Second outer surface

4 Kink in the form of a step

4a Transition zone

5 Axis of sight

6 Wearer's eye

1. A multifocal lens built in an inkjet printing process of depositing droplets of printing ink side by side and one above another in several consecutive depositing steps and curing the droplets in intermediate curing steps, wherein the multifocal lens comprises a first section providing a first optical function and a second section providing a second optical function that differs from the first optical function.

2. The multifocal lens according to claim 1, wherein the multifocal lens comprises a transition zone located between the first section and the second section.

3. The multifocal lens according to claim 2, wherein the transition zone extends substantially straight or curved from a first rim area of the transition zone to a second rim area of the transition zone of the multifocal lens.

4. The multifocal lens according to claim 3, wherein the first section is located in an upper part of the multifocal lens, wherein the second section is located in a lower part of the multifocal lens, and wherein the transition zone is located in a middle part between the upper part and the lower part of the multifocal lens.

5. The multifocal lens according to claim 2, wherein the multifocal lens comprises a kink located on at least one surface of the transition zone, wherein the kink preferably takes a form of a step.

6. The multifocal lens according to claim 5, wherein the kink extends substantially straight or curved from one rim area to another rim area of the multifocal lens.

7. The multifocal lens according to claim 5, wherein the step is sharp-edged having a curve radius of about 1 millimeter or less.

8. The multifocal lens according to claim 1, wherein the first section comprises a lens material having a first refractive index, and wherein the second section comprises a lens material having a second refractive index that differs from the first refractive index.

9. The multifocal lens according to claim 2, wherein the multifocal lens comprises a third section providing a third optical function, wherein the second section is located between the first section and the third section, and wherein a further transition zone is located between the second section and the third section.

10. A method for printing a multifocal lens comprising:
depositing droplets of printing ink side by side and one above another in several consecutive depositing steps, and
curing the droplets in intermediate curing steps,
wherein the depositing and curing steps are performed in such a manner that the multifocal lens is built up such that a first section of the multifocal lens provides a first optical function and a second section of the multifocal lens provides a second optical function differing from the first optical function.

11. The method according to claim 10, wherein a transition zone located between the first section and the second section and extending substantially straight or curved from one rim area to the another rim area of the multifocal lens is built up during the depositing and curing steps, wherein the multifocal lens is built up in such a manner that the transition zone comprises a kink located on at least one surface of the transition zone, and wherein the kink takes a form of a step.

12. The method according to claim 11, wherein the depositing steps are performed in such a manner that droplets deposited in an area of the kink have a reduced size in order to build up a sharp-edged kink having a curve radius of about 1 millimeter or less.

13. The method according to claim 11, wherein the curing steps are performed in such a manner that droplets deposited in an area of the kink have a reduced curing time in order to build up a sharp-edged kink having a curve radius of about 1 millimeter or less.

14. The method according to claim 10, wherein the first section is cured with a UV light of a first curing specification providing the first section with a first refractive index and the second section is cured with a UV light of a second curing specification providing the second section with a second refractive index.

15. The method according to claim 11, wherein the depositing and curing steps are performed in such a manner that the multifocal lens has further a third section providing a third optical function, wherein the second section is located between the first section and the third section and wherein a further transition zone is located between the second section and the third section.

16. The multifocal lens according to claim 1, wherein the multifocal lens is an ophthalmic multifocal lens.

17. The multifocal lens according to claim 7, wherein the step is sharp-edged having a curve radius of about 1 micrometer or less.

18. The method according to claim 12, wherein the depositing steps are performed in such a manner that droplets deposited in the area of the kink have a reduced size in order to build up a sharp-edged kink having a curve radius of about 1 micrometer or less.

19. The method according to claim 13, wherein the curing steps are performed in such a manner that droplets deposited in the area of the kink have a reduced curing time in order to build up a sharp-edged kink having a curve radius of about 1 micrometer or less.

20. The method according to claim 10, wherein the multifocal lens is an ophthalmic multifocal lens.
